(19) United States
(12) Patent Application Publication
(10) Pub. No.: US 2025/0027184 A1
(43) Pub. Date: Jan. 23, 2025

(54) METHOD FOR PREPARING SELF DOPED TITANIUM-NIOBIUM OXIDE NEGATIVE ELECTRODE MATERIAL USING WASTE TITANIUM DIOXIDE CARRIER, NEGATIVE ELECTRODE MATERIAL, AND LITHIUM-ION BATTERY

(71) Applicant: CHINA UNIVERSITY OF PETROLEUM-BEIJING, Beijing (CN)

(72) Inventors: Guoyong Huang, Beijing (CN); Jiawei Wen, Beijing (CN); Erkang Feng, Beijing (CN); Wenjie Zhang, Beijing (CN); Mingshuai Wu, Beijing (CN); Tongjun Shen, Beijing (CN)

(21) Appl. No.: 18/754,272

(22) Filed: Jun. 26, 2024

(30) Foreign Application Priority Data
Jul. 21, 2023 (CN) 202310905266.X

(51) Int. Cl. C22B 34/12; C22B 1/02; C22B 7/00; H01M 10/0525

(52) U.S. Cl. CPC C22B 34/1259; C22B 1/02; C22B 7/005; C22B 34/1213; C22B 34/1245; C22B 34/125; H01M 10/0525

(57) ABSTRACT

A method for preparing self-doped titanium-niobium oxide negative electrode material using a waste titanium dioxide carrier includes preparing self-doped TiNb₂O₇ negative electrode material for lithium-ion battery by using waste titanium dioxide carrier comprises the following steps: S1. converting a waste titanium dioxide carrier into TiO₂ powder with the Ti content of ≥95% and the Al content of 0.1-4.0%, based on the weight of oxide, respectively; and S2. mixing the TiO₂ powder and Nb₂O₅ powder to form a mixture, roasting the mixture, and collecting the generated Al self-doped TiNb₂O₇, so as to obtain the self-doped TiNb₂O₇ negative electrode material. According to the method disclosed by the present invention, impurities represented by TiO₂ and Al₂O₃ in the waste titanium dioxide carrier can be directly recycled, a self-doped TiNb₂O₇ (titanium niobium oxide) negative electrode material.

### TECHNICAL FIELD

The present invention belongs to the field of recycling high-value utilization of secondary resources from waste titanium dioxide carriers, and relates to a method for directly preparing lithium-ion battery material from waste. In particular, the present invention relates to a method for preparing titanium-based self-doped lithium-battery negative electrode material from waste titanium dioxide carrier.

### BACKGROUND

The advantages of titanium dioxide as a catalyst carrier lie in its high chemical stability, large specific surface area, low cost, simple process and so on. At the same time, it also has good performance, can use sunlight or ultraviolet light to excite its surface charge and thus promote the reaction. At present, catalysts using titanium dioxide as a carrier have been widely used in many fields, such as environmental pollution control, energy storage, organic materials and other fields. With the increasing use of titanium dioxide carriers, the number of titanium dioxide carriers scrapped every year is also increasing. If these scrapped catalyst carriers cannot be effectively recycled, they will not only pollute the environment, but also cause a waste of resources. Therefore, proper disposal of waste titanium dioxide carriers has strong economic benefits and environmental significance.

Lithium-ion batteries have the characteristics of high energy density, long life, and rapid charge and discharge. Currently, commercial lithium-ion batteries are not very capable in special battery usage areas, such as deep sea, polar regions, aviation and other application scenarios. This is mainly because most of them use layered graphite-based carbon materials as negative electrodes, which have low working potential (about 0.1V vs Li+/Li). During the charge and discharge process, “lithium dendrites” are easily generated, causing short circuits and restricting their further development. TiNb2O7 not only has the advantages of long cycle life and high safety, but also has a high theoretical specific capacity (387 mAh/g). Moreover, TiNb₂O₇ shows excellent structural stability during lithiation/delithiation and relatively high operating potential (1.6V relative to Li+/Li), which can effectively prevent the formation of “lithium dendrites” and greatly improve the safety of the battery system. At present, with the rapid development of the new energy industry and the saturation of the petroleum industry, the recovery and preparation of high-value materials from waste catalysts has become a more promising catalyst recycling route.

CN114058853A discloses a method for separating and recovering titanium, vanadium, and tungsten from waste SCR catalyst, which comprises the following contents: dusting and pulverizing the waste SCR catalyst, acidolyzing the waste catalyst powder using concentrated sulfuric acid, leaching the acidolysis product, and making titanium, tungsten, and vanadium in the waste catalyst enter the leach solution together, and then extracting titanium and tungsten using a weakly alkaline extractant, and stripping titanium from the loaded organic phase using sulfuric acid and hydrogen peroxide. However, the added value of the prepared product is low. Therefore, the preparation of new energy materials with higher added value has become a research frontier in the field.

### SUMMARY OF THE INVENTION

Based on the above content, in view of the problems existing in the present process such as long recycling process, large amount of waste acid and waste alkali used in the recycling process, and failure to utilize the recycled products in high value, the present invention provides a self-doped titanium-niobium-oxygen negative electrode material by using a waste titanium dioxide carrier, a negative electrode material and a lithium-ion battery. The method can directly recycle impurities represented by TiO2 and Al2O3 in the waste titanium dioxide carrier, directly prepare a self-doped TiNb2O7 (titanium niobium oxide) negative electrode material with excellent performance in a short process, realizes a high-value utilization of waste catalysts, improves environmental conditions and saves production costs.

The present invention provides a method for preparing a self-doped TiNb2O7 negative electrode material for lithium battery using waste titanium dioxide carrier, comprising the following steps:
S1. converting a waste titanium dioxide carrier into TiO2 powder with Ti content of ≥95% and Al content of 0.1-4.0%, based on the weight of oxide, respectively;
S2. mixing the TiO2 powder and Nb2O5 powder to obtain a mixture, roasting the mixture, and collecting the generated Al self-doped TiNb2O7, so as to obtain a self-doped TiNb2O7 negative electrode material.

In the present invention, the waste titanium dioxide carrier is a waste catalyst using titanium dioxide as a catalyst carrier, such as a waste SCR catalyst, a vanadium/titanium dioxide catalyst (V-TiO2) and other waste catalysts. In specific embodiments of the present invention, the preparation method of the present invention is described in detail, taking the waste SCR catalyst as a waste titanium dioxide carrier as an example.

In the above method for preparing a self-doped TiNb2O7 negative electrode material for lithium battery using waste titanium dioxide carrier, in step S1, qualified TiO2 powder is obtained by controlling the contents of the main impurity elements in the waste TiO2 carrier after impurity removal, that is, the TiO2 powder; if the Ti content and Al content are not up to standard, a secondary impurity removal is required; based on the weight of oxide, the content of Al in the TiO2 powder is preferably 0.1 to 3.0%, more preferably 0.1 to 2.0%;
based on the weight of oxide, the content of impurity V in the TiO2 powder is controlled at 0.01% to 0.3%, preferably 0.01% to 0.1%;
based on the weight of oxide, the content of impurity W in the TiO2 powder is controlled at 0.1% to 1.0%, preferably 0.1% to 0.5%.

In the present invention, based on the weight of oxide, means that, the Ti content is calculated as TiO2, the Al content is calculated as Al2O3, the V content is calculated as V2O5, and the W content is calculated as WO3. In a specific embodiment of the present invention, after the TiO2 powder is digested with an acid, the content of each of the elements is obtained by ICP, and the digestion can be digested using HF or aqua regia.

In the above method for preparing a self-doped TiNb2O7 negative electrode material for lithium battery using waste titanium dioxide carrier, preferably, a mass percentage of titanium dioxide in the waste titanium dioxide carrier is 70% to 95%;
a mass percentage of aluminum oxide in the waste titanium dioxide carrier is 4% to 10%;
a mass percentage of tungsten trioxide in the waste titanium dioxide carrier is 2% to 3%;
a mass percentage of vanadium pentoxide in the waste titanium dioxide carrier is 1% to 3%.

In a specific embodiment of the present invention, based on the total weight of the waste titanium dioxide carrier, the waste titanium dioxide carrier comprises 76.50 wt % of titanium dioxide, 5.31 wt % of aluminum oxide, 2.94wt % of tungsten trioxide, 0.93 wt % of vanadium pentoxide, 8.39 wt % of silica oxide and 0.30 wt % of molybdenum trioxide.

In the above method for preparing a self-doped TiNb2O7 negative electrode material for lithium battery using waste titanium dioxide carrier, preferably, the converting in step S1comprising:
S10. physically crushing, washing and ball-milling the waste titanium dioxide carrier to obtain waste titanium dioxide carrier powder;
S11. mixing the waste titanium dioxide carrier powder and a sodium roasting material and roasting a resulting mixture to convert the titanium dioxide into titanium sodium salt, so as to obtain a clinker;
S12. performing a first leaching of the clinker using water as a leaching reagent, collecting a first leaching residue, and drying the first leaching residue;
S13. performing a second leaching of the first leaching residue using acid as a leaching reagent, and collecting a second leaching solution;
S14. adding an alkaline reagent to the second leaching solution, collecting a precipitate, drying and roasting the precipitate in sequence, so as to obtain a TiO2 powder.

The inventive concept of step S1 in the present invention is as follows:

TiO2 is separated using “sodium roasting+water leaching+acid leaching precipitation+roasting”. The metal oxides in the waste catalyst are converted into corresponding sodium salts (such as Na2TiO3, Na2WO4, NaVO3, etc.) through sodium roasting. The water-soluble components in the sodium salt are removed by water leaching, and the water-insoluble sodium titanium salts (such as Na2TiO3, Na8Ti5O14, etc.) can be dissolved in the solution by acid leaching. And then an appropriate amount of alkali is added to precipitate Ti by adjusting the pH of the solution. Finally, relatively pure TiO2 is obtained through high-temperature roasting.

The inventors of the present invention discovered during the research process that by using the above conversion method and controlling specific heat treatment conditions and leaching reagents, the TiO2 powder with higher content can be obtained, effectively leaching impurity ions efficiently and directly preparing high-value materials.

In step S10, the washing is washing with water and then drying. In a specific embodiment of the present invention, ultrasonic washing with deionized water is used to remove the fly ash impurities on the surface followed by drying in a vacuum drying oven at 60° C.

Preferably, the ball milling is passing the the waste titanium dioxide carrier through a 325-mesh sieve. The inventors found that the preferred embodiment can effectively reduce the particle size of the catalyst, which is beneficial to the subsequent heat treatment process.
the sodium roasting material is sodium carbonate or sodium hydroxide. In a specific embodiment of the present invention, the waste titanium dioxide carrier powder and the sodium roasting material are fully mixed in an agate mortar;
a mass ratio of the waste titanium dioxide carrier powder to the sodium roasting material can be 1: (2-3), specifically it can be 1:2, 1:2.5 or 1:3;
the roasting in step S11 is performed in an air atmosphere, a roasting temperature can be 650° C. to 850° C., such as 700° C., 650° C. or 750° C., and a holding time of the roasting is 6 hours, to achieve a complete reaction of titanium dioxide. In a specific embodiment of the present invention, a heating rate is 5° C./min.

In step S11, taking sodium carbonate as the roasting material as an example, the reaction equation that may occur during the sodium roasting process is as follows:

TiO2+Na2CO3→Na2TiO3+CO2↑

Al2O3+Na2CO3→2NaAlO2+CO2↑

WO3+Na2CO3→Na2WO4+CO2↑

V2O5+Na2CO3→2NaVO3+CO2↑

SiO2+Na2CO3→Na2SiO3+CO2↑

MoO3+Na2CO3→Na2MoO4+CO2↑

Through the above reactions, each of the elements in the waste titanium dioxide carrier is converted into the corresponding sodium salt.

The step S11 further comprises passing the clinker through a 200-mesh sieve for later use.

In step S12, preferably, a temperature of the first leaching can be 60° C. to 90° C., such as 60 to 80° C., 60° C., 70° C. or 80° C.

A time of the first leaching time is 1 h to 10 h, such as 6 h.

A material-to-liquid ratio of the first leaching can be 1 g:30 mL.

Under the above conditions, the main components in the first leaching solution are NaVO3, Na2WO4, and NaAlO2, etc. The main components of the first leaching residue are titanium-containing sodium salts such as Na2TiO3, Na8Ti5O14, and Na2Ti3O7, as well as a small portion of unreacted Al2O3 and other impurity elements.

The drying of the first leaching residue is vacuum drying, and a temperature of the drying can be 60° C. to 90° C. (such as 60° C.), for a time of 12 hours.

In step S13, preferably, the acid is one or more of H2SO4 and HCl.

The acid is existed in the form of an aqueous solution, and a concentration of the acid in the aqueous solution can be 3 to 5 mol/L, such as 5 mol/L.

The second leaching can be performed in a temperature of 80-90° C., such as 80° C.

The second leaching can be performed for a time of 5 to 24 hours, such as 6 hours.

A material-to-liquid ratio of the second leaching is 1 g:30 mL, such as 1 g:30 mL.

Under the above conditions, a main component in the second leaching solution is TiOSO4.

In step S13, taking H2SO4 as the leaching acid as an example, a reaction equation that

may occur during the leaching process is as follows:

Na2TiO3+2H+→H2TiO3+2Na+

H2TiO3+SO42−+2H+→TiO2++SO42−+H2O

Through the above reaction, the water-insoluble sodium titanium salt in the waste titanium dioxide carrier is dissolved in the acid.

In the present invention, the leaching solution or leaching residue can be collected by solid-liquid separation of the leached system. The solid-liquid separation method includes but is not limited to centrifugation and other separation methods.

In step S13, preferably, the alkaline reagent can be one or more of ammonia, Na2CO3, NaOH, or urea.

The alkaline reagent is added in the form of an aqueous solution with a concentration of 1 to 100 g/L, such as 100 g/L.

The aqueous solution of the alkaline reagent is added dropwise in at a rate of 0.5 to 1 ml/min, such as 0.5 ml/min.

An addition amount of the alkaline reagent is controlled so that the pH value of the system can be 2.5 to 5, such as 4 to 5, 4 or 5;

The precipitate is H2TiO3, and TiO2+ in the solution is completely precipitated by adjusting pH in the solution using the alkaline reagent. Taking H2SO4 as the leaching acid as an example, a reaction equation that may occur when adding an alkali solution is as follows:

TiO2++SO42 −+H2O→H2TiO3+SO42−+2H+

In step S14, the drying is vacuum drying, a temperature of the drying is 60-80° C., such as 60° C., for a time of 12-24 h, such as 12 h.

In step S14, the roasting is performed in an air atmosphere, a temperature of the roasting is 600° C., and a holding time of the roasting is 3 to 5 hours (such as 3 hours). In the specific embodiment of the present invention, a heating rate is set to 5° C./min. A reaction equation is as follows:

H2TiO3→TiO2+H2O↑

In the above method for preparing self-doped TiNb2O7 negative electrode material for lithium battery using waste titanium dioxide carrier, in step S2, it is prepared by a high-temperature solid phase method;
optionally, the Nb2O5 powder is commercial Nb2O5 material;
preferably, a molar ratio of the TiO2 powder to the Nb2O5 powder is 1.05:1;
the TiO2 powder and the Nb2O5 powder are mixed and then passed through a 325-mesh sieve to obtain a powder precursor with a particle size ≤45 μm.

In step S2, the roasting is performed in an air atmosphere, a temperature of the roasting can be 1100° C. to 1300° C., such as 1100° C., 1150° C., 1300° C., and a holding time of the roasting can be 8 to 12 hours, such as 10 hours. In a specific embodiment of the present invention, a heating rate is 5° C./min.

In a specific embodiment of the invention, the roasting is performed in a muffle furnace.

The present invention further provides a self-doped TiNb2O7 negative electrode material prepared by the method for preparing self-doped TiNb2O7 negative electrode material for lithium battery using waste titanium dioxide carrier as described in any one of the above.

The invention also provides a lithium-ion battery, which comprises a positive electrode sheet, a negative electrode sheet, a separator and an electrolyte. The negative electrode sheet comprises a current collector and the self-doped TiNb2O7 negative electrode material loaded on the current collector.

For example, the current collector is copper foil; the positive electrode sheet is a lithium metal sheet; the separator is a PE separator; and the electrolyte is EC:DMC=1:1 (vol) containing 1 mol/L LiPF6.

The present invention has the following beneficial effects:
(1) The present invention prepares a Al self-doped lithium-ion battery negative electrode material TiNb2O7 using a waste titanium dioxide carrier containing aluminum oxide, realizing the preparation of a new type of ultra-fast charging negative electrode material-titanium niobium oxide TiNb2O7 using waste TiO2 carrier, which can be used in a lithium-ion battery negative electrode material and increases economic added value. It is found that compared to the undoped TiNb2O7 negative electrode material, the Al self-doped lithium-ion battery negative electrode material TiNb2O7 has excellent cycle stability performance during the subsequent charge and discharge process, although the initial specific capacity thereof is slightly lower than that of the undoped commercial material.
(2) The present invention removes impurities through pretreatment, and converts a waste titanium dioxide carrier into TiO2 powder with Ti content (calculated as TiO2, the same below) of ≥95% and Al content (calculated as Al2O3, the same below) of 0.1-4.0%, grinds the mixture of the commercial Nb2O5 material and the TiO2 powder, and then roast the ground powder using a high-temperature solid-state method to obtain a Al self-doped TiNb2O7 product.
(3) The TiO2 powder with the required Ti content and aluminum content can be obtained by reasonably adjusting the sodium roasting pretreatment temperature and combining water leaching and acid leaching precipitation conditions.

### BRIEF DESCRIPTION OF THE DRAWINGS

FIG. 1 is a flow chart for preparing self-doped TiNb2O7 negative electrode material for lithium battery using waste titanium dioxide carrier according to the present invention.

FIG. 2 is an XRD spectrum of the self-doped TiNb2O7 negative electrode material sample prepared in Example 1.

FIG. 3 is a SEM-EDS photo of the self-doped TiNb2O7 negative electrode material sample prepared in Example 1.

FIG. 4 is a comparison graph of the first five cycles of charge and discharge performance between the self-doped TiNb2O7 negative electrode material prepared in Example 1 (left) and the TiNb2O7 negative electrode material prepared from commercial materials (right).

FIG. 5 is a CV performance test graph of the self-doped TiNb2O7 negative electrode material prepared in Example 1 at 1.0-3.0V with a scan speed of 0.1 mV/s.

FIG. 6 is an impedance performance graph of the battery of the self-doped TiNb2O7 negative electrode material prepared in Example 1 after being activated 3 times and cycled 10 times, 20 times, 50 times, and 100 times at a rate of 1 C.

### DETAILED DESCRIPTION

The present invention will be described in further detail below in combination with specific embodiments. The examples given are only for illustrating the present invention and are not intended to limit the scope of the present invention. The examples provided below can serve as a guide for those skilled in the art to make further improvements, and do not limit the present invention in any way.

The experimental methods used in the following examples are conventional methods unless otherwise specified; the materials, reagents, etc. used can be obtained from commercial sources unless otherwise specified.

In the following examples, based on the total weight of the waste titanium dioxide carrier, the waste titanium dioxide carrier comprises 76.50 wt % of titanium dioxide, 5.31 wt % of aluminum oxide, 2.94 wt % of tungsten trioxide, 0.93 wt % of vanadium pentoxide, 8.39 wt % of silicon dioxide and 0.30 wt % of molybdenum trioxide.

The purity of commercial TiO2 in the following comparative examples is 99%.

The roasting in the following examples is performed in an air atmosphere (in a muffle furnace) unless otherwise specified.

### Example 1

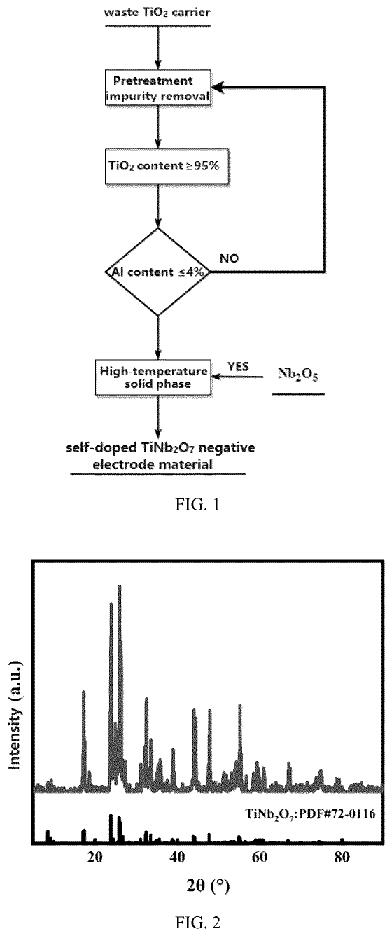

This example provides a method for preparing self-doped negative electrode material TiNb2O7 for lithium battery using waste titanium dioxide carrier. As shown in FIG. 1, the method comprised the following steps.
(1) A waste titanium dioxide carrier was physically crushed, followed by ultrasonic washing with deionized water to remove the surface fly ash impurities, and then dried in a vacuum drying oven at 60° C. The dried waste titanium dioxide carrier was ball milled through a 325 mesh sieve.
(2) 5.00 g of waste titanium dioxide carrier and 10.00 g of Na2CO3 were placed in a corundum crucible, mixed and ground evenly. The resulting mixture was then placed in a muffle furnace for roasting (roasting temperature of 700° C., holding time of 6 h, heating rate of 5° C./min), and cooled in the furnace. After cooled, the sample was took out to obtain 13.64 g of heat-treated clinker. The heat-treated clinker comprised Na2TiO3, Na8Ti5O14, Na2Ti3O7, NaAlO2, NaVO3, Na2WO4, etc. And the heat-treated clinker was passed through a 200 mesh sieve for later use.
(3) 3 g of the above heat-treated clinker and 90 ml of deionized water were placed in a 250 ml beaker, leached in warm water at 60° C. for 6 hours, and then centrifuged at a low speed to obtain a first leaching solution and a first leaching residue. The first leaching residue was dried in a drying oven at 60° C. for 12 hours to obtain a dry sample.
(4) 1 g of the dry sample and 30 ml 5 mol/L H2SO4 were placed into a 100 ml beaker, leached in a water bath at 80° C. for 6 hours, and then centrifuged at a low speed to obtain a second leaching solution and a second leaching residue.
(5) 10 ml of the second leaching solution was measured and placed in a 100 ml beaker for stirring, a 50 g/L ammonia solution was slowly added dropwise into the mixed solution at a rate of 0.5 ml/min using a peristaltic pump until the pH value reached 5.
(6) The mixture was vacuum filtered and dried at 80° C. for 24 hours in a vacuum drying box, then roasted in a muffle furnace (roasting temperature of 600° C., holding time of 3 h, heating rate of 5° C./min) to obtain a TiO2 powder. After testing, the contents of the elements are as follows: Ti content (calculated as TiO2) was 96.88%, Al content (calculated as Al2O3) was 2.91%, V content (calculated as V2O5) was 0.08%, W content (calculated as WO3) was 0.98%, and then commercial Nb2O5 powder was added, mixed and milled in a molar ratio of TiO2:Nb2O5=1.05:1, and then passed through a 325 mesh sieve to obtain a mixed powder with particle size ≤45 μm.
(7) The mixed powder was placed into the muffle furnace for roasting (roasting temperature of 1000° C., holding time of 10 h, heating rate of 5° C./min), and cooled in the furnace. A self-doped lithium battery negative electrode material for lithium ion battery TiNb2O7 was obtained.

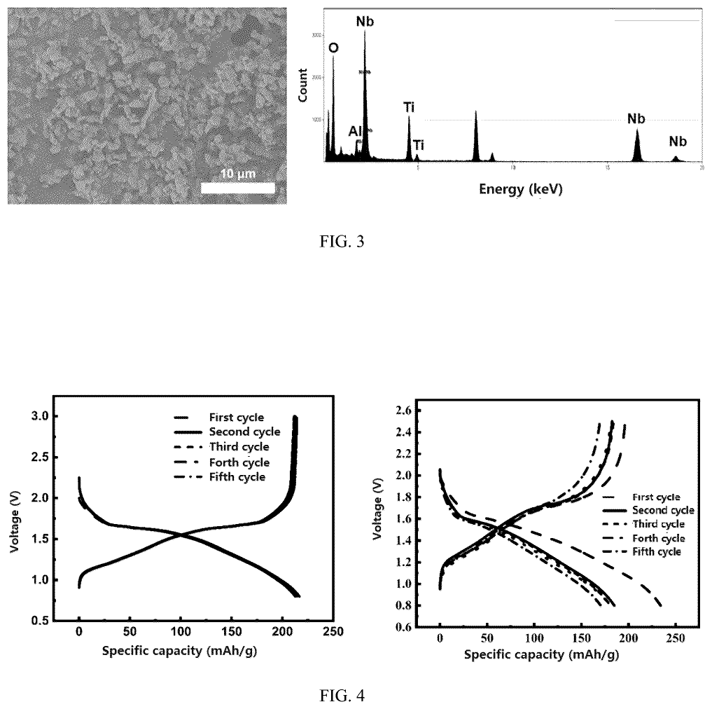

The XRD of the Al self-doped TiNb2O7 negative electrode material obtained in this example is shown in FIG. 2, and the SEM-EDS result is shown in FIG. 3. The first five cycles of charge and discharge performances of Al-self-doped TiNb2O7 (calculated as Al—TNO, the same below) and TiNb2O7 (calculated as TNO, the same below) prepared from commercial materials were compared. The specific steps were as follows: Al—TNO/TNO, acetylene black and polyvinylidene fluoride (PVDF) were mixed in a weight ratio of 8:1:1 to prepare Al—TNO/TNO electrode sheets; the mass fraction of the binder was 7% and the solvent was N-methylorrhoidone (NMP). The prepared slurry was stirred in a stirrer for 12 hours; the evenly stirred slurry was coated on the copper foil with a coating thickness of 100 μm; then dried continuously in a vacuum drying oven at 90° C. for 12 hours to remove excess NMP and water. After drying, the obtained material was cut into circular pole pieces with a diameter of 12 mm, weighed and placed in a glove box for later use. The prepared electrode sheet was used as the positive electrode, the lithium metal piece was used as the counter electrode (diameter 16 mm), the separator was PE (diameter 19 mm), and the electrolyte was EC:DMC=1:1 (vol) containing 1 mol/L LiPF6. The CR2032 button-type half-cell was assembled in the glove box. The battery performance was tested using the CT2001A blue battery test system. The assembled battery was charged and discharged 3 times at a rate of 0.1 C to activate the battery. The test range of the battery was 0.8-3.0V. The scanning speed of CV was between 0.1 and 1 mv s−1. All tests were performed at room temperature. As shown in FIG. 4, compared with the commercial TNO material (right in FIG. 4), after self-doping, the Al—TNO material (left in FIG. 4) has a lower charge and discharge capacity attenuation in the first five cycles, indicating that the battery is more stable after Al doping.

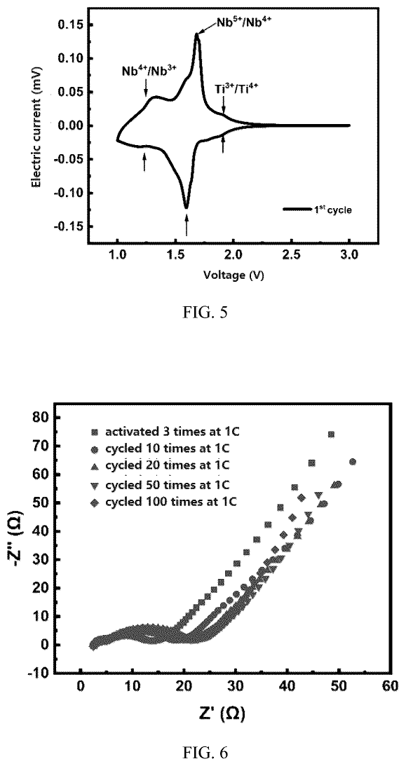

FIG. 5 shows the CV performance test graph of the Al—TNO material at 1.0-3.0V and a sweep speed of 0.1 mV/s. It can be seen that the CV curve of the Al—TNO material completely reflects three redox pairs.

The impedance performance of Al—TNO was tested; the frequency range of the test was 0.01-105 Hz and the amplitude of the sinusoidal alternating current signal was 5 mV. The battery impedance test was performed using Shanghai Chenhua CHI760E electrochemical workstation. FIG. 6 shows the impedance performance graph of the battery after being activated 3 times and cycled 10 times, 20 times, 50 times, and 100 times at a rate of 1 C. It can be seen that the initial electrochemical polarization resistance Rct of the battery is about 3 Ω, and increased after cycling and activation; especially after 100 cycles, the impedance increases from the initial 3Ω to about 22Ω. It indicates that the initial performance of the battery will be slightly reduced after Al doped, but the battery capacity will decay slowly. This may be because the addition of Al stabilizes the lattice gap.

The properties of the battery material prepared in this example are shown in Table 1.

### Example 2

This example used a method similar to that in Example 1 to prepare a titanium-based self-doped lithium battery negative electrode material TiNb2O7 using a waste titanium dioxide carrier. The difference was that in step (7), the roasting temperature was 1150° C. and the time was 8 hours.

The properties of the battery material prepared in this example are shown in Table 1.

### Example 3

This example used a method with (1) to (4) similar to that in Example 1 to prepare a titanium-based self-doped lithium battery negative electrode material TiNb2O7 using a waste titanium dioxide carrier. The difference were as follows: in step (5), the second leaching solution of 10 ml was placed in a 100 ml beaker for stirring, and an aqueous solution of urea (100 g/L) was slowly added dropwise into the mixed solution using a peristaltic pump at a rate of 0.5 ml/min until the pH value reached 4.
(6) the precipitate was filtered and dried in a vacuum drying oven at 60° C. for 12 hours to obtain a crystal, after the crystal was milled in a mortar and then roasted in a muffle furnace (roasting temperature of 600° C., holding time of 3 hours, heating rate of 5° C./min) to obtain a TiO2 powder. After testing, the contents of the elements were as follows: Ti content (calculated as TiO2) was 97.03%, Al content (calculated as Al2O3) was 2.89%, V content (content calculated as V2O5) was 0.15%, and W content (calculated as WO3) was 0.21%.
(7) TiO2 and commercial Nb205 were mixed and milled at a molar ratio of 1.05:1 and then passed through a 325 mesh sieve to obtain a powder precursor with particle size of ≤45 μm.
(8) the mixed powder was placed into a muffle furnace for roasting (roasting temperature of 1100° C., holding time of 10 h, heating rate of 5° C./min), and cooled in the furnace. A self-doped lithium battery negative electrode material TiNb2O7 for lithium ion battery was obtained.

The properties of the battery material prepared in this example are shown in Table 1.

Example 4

This example used a method similar to that in Example 3 to prepare a titanium-based self-doped lithium battery negative electrode material TiNb2O7 using a waste titanium dioxide carrier. The difference was as follows: in step (2), NaOH was used as the added material. In step (6), after testing, the contents of the elements were as follows: Ti content (calculated as TiO2) was 96.66%, Al content (calculated as Al2O3) was 3.77%, V content (content calculated as V2O5) was 0.28%, and W content (calculated as WO3) was 0.19%.

The properties of the battery material prepared in this example are shown in Table 1.

### Example 5

This example used a method similar to that in Example 3 to prepare a titanium-based self-doped lithium battery negative electrode material TiNb2O7 using a waste titanium dioxide carrier. The difference was as follows: in step (5), NaOH was used as the added material. In step (6), after testing, the contents of the element were as follows: Ti content (calculated as TiO2) was 97.11%, Al content (calculated as Al2O3) was 2.43%, V content (content calculated as V2O5) was 0.09%, and W content (calculated as WO3) was 0.17%.

The properties of the battery material prepared in this example are shown in Table 1.

### Example 6

This example used a method similar to that in Example 3 to prepare a titanium-based self-doped lithium battery negative electrode material TiNb2O7 using a waste titanium dioxide carrier. The difference was that in step (8), the roasting temperature was 1300° C.

The properties of the battery material prepared in this example are shown in Table 1.

### Example 7

This example used a method similar to that in Example 1 to prepare a titanium-based self-doped lithium battery negative electrode material TiNb2O7 using a waste titanium dioxide carrier. The difference was as follows: in step (2), the amount of sodium carbonate was 12.5 g, that is, the ratio of the additive to the waste titanium dioxide carrier was 2.5. In step (6), after testing, the contents of the elements were as follows: Ti content (calculated as TiO2) is 95.58%, Al content (calculated as Al2O3) is 3.89%, V content (content calculated as V2O5) is 0.12%, W content (calculated as WO3) is 0.21%.

The properties of the battery material prepared in this example are shown in Table 1.

### Example 8

This example used a method similar to that in Example 1 to prepare a titanium-based self-doped lithium battery negative electrode material TiNb2O7 using a waste titanium dioxide carrier. The difference was as follows: in step (2), the amount of sodium carbonate was 15 g, that is, the ratio of the additive to the waste titanium dioxide carrier was 3. In step (6), after testing, the contents of the element were as follows: Ti content (calculated as TiO2) was 96.76%, Al content (calculated as Al2O3) was 3.11%, V content (content calculated as V2O5) was 0.08%, and W content (calculated as WO3) was 0.10%. The properties of the battery material prepared in this example are shown in Table 1.

### Example 9

This example used a method similar to that in Example 1 to prepare a titanium-based self-doped lithium battery negative electrode material TiNb2O7 using a waste titanium dioxide carrier. The difference was as follows: in step (2), the roasting temperature was 650° C. In step (6), after testing, the contents of the element were as follows: Ti content (calculated as TiO2) was 95.99%, Al content (calculated as Al2O3) was 3.76%, V content (content calculated as V2O5) was 0.19%, and W content (calculated as WO3) was 0.22%.

The properties of the battery material prepared in this example are shown in Table 1.

### Example 10

This example used a method similar to that in Example 1 to prepare a titanium-based self-doped lithium battery negative electrode material TiNb2O7 using a waste titanium dioxide carrier. The difference was as follows: in step (2), the roasting temperature was 750° C. In step (6), after testing, the contents of the element were as follows: Ti content (calculated as TiO2) was 96.81%, Al content (calculated as Al2O3) was 2.93%, V content (calculated as V2O5) was 0.06%, and W content (calculated as WO3) was 0.17%.

The properties of the battery material prepared in this example are shown in Table 1.

### Example 11

This example used a method similar to that in Example 2 to prepare a titanium-based self-doped lithium battery negative electrode material TiNb2O7 using a waste titanium dioxide carrier. The difference was as follows: in step (3), the leaching temperature was 70° C. In step (6), after testing, the contents of the elements were as follows: Ti content (calculated as TiO2) was 98.03%, Al content (calculated as Al2O3) was 3.15%, V content (calculated as V2O5) was 0.03%, and W content (calculated as WO3) was 0.16%.

### Example 12

This example used a method similar to that in Example 2 to prepare a titanium-based self-doped lithium battery negative electrode material TiNb2O7 using a waste titanium dioxide carrier. The difference was as follows: in step (3), the leaching temperature was 80° C. In step (6), after testing, the contents of the elements were as follows: Ti content (calculated as TiO2) is 98.64%, Al content (calculated as Al2O3) was 2.78%, V content (calculated as V2O5) was 0.05%, and W content (calculated as WO3) was 0.21%.

### Comparative Example 1

This example used a method similar to Example 1 to prepare a titanium-based lithium battery negative electrode material TiNb2O7. The difference was as follows: steps (1) to (5) were cancelled, and in step (6), a commercial TiO2 was mixed with Nb2O5.

The properties of the battery material prepared in this comparative example are shown in Table 1.

### Comparative Example 2

This example used a method similar to that of Example 2 to prepare a titanium-based lithium battery negative electrode material TiNb2O7. The difference was that in step (6), a commercial TiO2 was mixed with Nb2O5.

The properties of the battery material prepared in this comparative example are shown in Table 1.

### Comparative Example 3

This example used a method similar to that of Example 3 to prepare a titanium-based lithium battery negative electrode material TiNb2O7. The difference was that in step (7), a commercial TiO2 was mixed with Nb2O5.

The properties of the battery material prepared in this comparative example are shown in Table 1.

### Comparative Example 4

This example used a method similar to that of Example 4 to prepare a titanium-based lithium battery negative electrode material TiNb2O7. The difference was that in step (7), a commercial TiO2 was mixed with Nb2O5.

The properties of the battery material prepared in this comparative example are shown in Table 1.

### Comparative Example 5

This example used a method similar to that of Example 5 to prepare a titanium-based lithium battery negative electrode material TiNb2O7. The difference was that in step (7), a commercial TiO2 was mixed with Nb2O5.

The properties of the battery material prepared in this comparative example are shown in Table 1.

### Comparative Example 6

This example used a method similar to that of Example 6 to prepare a titanium-based lithium battery negative electrode material TiNb2O7. The difference was that in step (7), a commercial TiO2 was mixed with Nb2O5.

The properties of the battery material prepared in this comparative example are shown in Table 1.

### Comparative Example 7

This example used a method similar to that of Example 7 to prepare a titanium-based lithium battery negative electrode material TiNb2O7. The difference was that in step (6), a commercial TiO2 was mixed with Nb2O5.

The properties of the battery material prepared in this comparative example are shown in Table 1.

### Comparative Example 8

This example used a method similar to that of Example 8 to prepare a titanium-based lithium battery negative electrode material TiNb2O7. The difference was that in step (6), a commercial TiO2 was mixed with Nb2O5.

The properties of the battery material prepared in this comparative example are shown in Table 1.

### Comparative Example 9

This example used a method similar to that of Example 9 to prepare a titanium-based lithium battery negative electrode material TiNb2O7. The difference was that in step (7), a commercial TiO2 was mixed with Nb2O5.

The properties of the battery material prepared in this comparative example are shown in Table 1.

### Comparative Example 10

This example used a method similar to that of Example 10 to prepare a titanium-based lithium battery negative electrode material TiNb2O7. The difference was that in step (6), a commercial TiO2 was mixed with Nb2O5.

The properties of the battery material prepared in this comparative example are shown in Table 1.

### Comparative Example 11

This example used a method similar to that of Example 11 to prepare a titanium-based lithium battery negative electrode material TiNb2O7. The difference was that in step (6), a commercial TiO2 was mixed with Nb2O5.

The properties of the battery material prepared in this comparative example are shown in Table 1.

### Comparative Example 12

This example used a method similar to that of Example 12 to prepare a titanium-based lithium battery negative electrode material TiNb2O7. The difference was that in step (6), a commercial TiO2 was mixed with Nb2O5.

The properties of the battery material prepared in this comparative example are shown in Table 1.

TABLE 1
Battery material properties of various
examples and comparative examples

| | First discharge specific | Capacity after 100 |
|---|---|---|
| | capacity/(mAh/g) | cycles/(0.1 C) |
| Example 1 | 223.6 | 218.5 |
| Example 2 | 210.9 | 199.6 |
| Example 3 | 225.3 | 214.3 |
| Example 4 | 213.5 | 209.7 |
| Example 5 | 221.3 | 213.4 |
| Example 6 | 203.9 | 188.6 |
| Example 7 | 206.8 | 195.4 |
| Example 8 | 215.8 | 200.3 |
| Example 9 | 210.4 | 201.6 |
| Example 10 | 220.9 | 204.91 |
| Example 11 | 211.1 | 199.3 |
| Example 12 | 217.4 | 206.6 |
| Comparative Example 1 | 242.4 | 130.3 |
| Comparative Example 2 | 257.9 | 140.4 |
| Comparative Example 3 | 232.8 | 141.2 |
| Comparative Example 4 | 241.3 | 132.0 |
| Comparative Example 5 | 218.6 | 129.2 |
| Comparative Example 6 | 225.4 | 142.7 |
| Comparative Example 7 | 238.8 | 124.7 |
| Comparative Example 8 | 246.1 | 165.2 |
| Comparative Example 9 | 240.1 | 157.7 |
| Comparative Example 10 | 245.7 | 169.3 |
| Comparative Example 11 | 238.8 | 149.2 |
| Comparative Example 12 | 240.1 | 158.3 |

It can be seen from Table 1 that, compared with the undoped TiNb2O7 negative electrode material, the aluminum self-doped TiNb2O7 lithium battery negative electrode material prepared by the present invention has an initial specific capacity slightly lower than that of the undoped commercial material, but has excellent cycle stability performance during the subsequent charge-discharge process.

The present invention has been described in detail above. For those skilled in the art, the present invention can be implemented in a wider range under equivalent parameters, concentrations and conditions without departing from the spirit and scope of the present invention. Although specific embodiments of the present invention have been shown, it should be understood that further modifications can be made to the invention. In short, based on the principles of the present invention, the present application is intended to include any changes, uses, or improvements to the present invention, including changes that depart from the scope disclosed in this application and are made using conventional techniques known in the art

1. A method for preparing self-doped TiNb₂O₇ negative electrode material for a lithium battery using waste titanium dioxide carrier, wherein the method comprises following steps:
S1. converting a waste titanium dioxide carrier into TiO₂ powder with Ti content of ≥95% and Al content of 0.1-4.0%, based on the weight of oxide, respectively;
S2. mixing the TiO₂ powder and Nb₂O₅ powder to form a mixture, roasting the mixture, and collecting the generated Al self-doped TiNb₂O₇, so as to obtain the self-doped TiNb₂O₇ negative electrode material.

2. The method for preparing self-doped TiNb₂O₇ negative electrode material for a lithium battery using waste titanium dioxide carrier according to claim 1, wherein based on the weight of oxide, the content of Al in the TiO₂ powder is 0.1% to 3.0%;
based on the weight of oxide, the content of impurity V in the TiO₂ powder is controlled at 0.01% to 0.3%, preferably 0.01% to 0.1%;
based on the weight of oxide, the content of impurity W in the TiO₂ powder is controlled at 0.1% to 1.0%, preferably 0.1% to 0.5%.

3. The method for preparing self-doped TiNb₂O₇ negative electrode material for a lithium battery using waste titanium dioxide carrier according to claim 1, wherein a mass percentage of titanium dioxide in the waste titanium dioxide carrier is 70% to 95%;
a mass percentage of aluminum oxide in the waste titanium dioxide carrier is 4% to 10%;
a mass percentage of tungsten trioxide in the waste titanium dioxide carrier is 2% to 3%;
a mass percentage of vanadium pentoxide in the waste titanium dioxide carrier is 1% to 3%.

4. The method for preparing self-doped TiNb₂O₇ negative electrode material for a lithium battery using waste titanium dioxide carrier according to claim 1, wherein the converting in step S1 comprising:
S10. physically crushing, washing and ball-milling the waste titanium dioxide carrier to obtain a waste titanium dioxide carrier powder;
S11. mixing the waste titanium dioxide carrier powder and a sodium roasting material and roasting the resulting mixture to convert the titanium dioxide into titanium sodium salt, so as to obtain a clinker;
S12. performing a first leaching of the clinker using water as a leaching reagent, collecting a first leaching residue, and drying the first leaching residue;
S13. performing a second leaching of the first leaching residue using an acid as a leaching reagent, and collecting a second leaching solution;
S14. adding an alkaline reagent to the second leaching solution, collecting precipitates, drying and roasting the precipitates in sequence, so as to obtain a TiO₂ powder.

5. The method for preparing self-doped TiNb₂O₇ negative electrode material for a lithium battery using waste titanium dioxide carrier according to claim 4, wherein the ball milling the waste titanium dioxide carrier is passing the the waste titanium dioxide carrier through a 325-mesh sieve;
the sodium roasting material is sodium carbonate or sodium hydroxide;
a mass ratio of the waste titanium dioxide carrier powder to the sodium roasting material is 1: (2-3);
the roasting in step S11 is performed in an air atmosphere, a roasting temperature is 650° C. to 850° C., and a holding time is 6 hours.

6. The method for preparing self-doped TiNb₂O₇ negative electrode material for a lithium battery using waste titanium dioxide carrier according to claim 4, wherein the step S11 further comprises passing the clinker through a 200-mesh sieve for later use;
a temperature of the first leaching is 60° C. to 90° C.;
a time of the first leaching time is 1 h to 10 h;
a material-to-liquid ratio of the first leaching is 1 g:30 mL;
the drying of the first leaching residue is vacuum drying at a temperature of 60° C. to 90° C. for a time of 12 hours.

7. The method for preparing self-doped TiNb₂O₇ negative electrode material for a lithium battery using waste titanium dioxide carrier according to claim 4, wherein the acid is one or more of H₂SO₄ and HCl;
the acid exists in the form of an aqueous solution with a concentration of 3 to 5 mol/L;
the second leaching is preformed at a temperature of 80-90° C.;
the second leaching is preformed for a time of 5 to 24 hours;
the second leaching is preformed at a material-to-liquid ratio of 1 g:30 mL;
the alkaline reagent is one or more of ammonia, Na₂CO₃, NaOH, and urea;
the alkaline reagent is added in the form of an aqueous solution with a concentration of 1 to 100 g/L;
the alkaline reagent is added in a form of an aqueous solution at a rate of 0.5 to 1 ml/min;
the alkaline reagent is controlled at an added amount to the pH value of the system is 2.5 to 5;
the drying in step S14 is vacuum drying, a temperature of the drying is 60 to 80° C., and a time of the drying is 12 to 24 hours;
the roasting in step S14 is performed in an air atmosphere, a temperature of the roasting is 600° C., and a holding time of the roasting is 3 to 5 hours.

8. The method for preparing self-doped TiNb₂O₇ negative electrode material for a lithium battery using waste titanium dioxide carrier according to claim 1, wherein a molar ratio of the TiO₂ powder to the Nb₂O₅ powder is 1.05:1;
the TiO₂ powder and the Nb₂O₅ powder are mixed followed by passing through a 325-mesh sieve;
the roasting in step S2 is performed in an air atmosphere, a temperature of the roasting is 1100° C. to 1300° C., and a holding time of the roasting is 8 to 12 hours.

9. A self-doped TiNb₂O₇ negative electrode material prepared by the method for preparing self-doped TiNb₂O₇ negative electrode material for a lithium battery using waste titanium dioxide carrier according to claim 1.

10. A lithium-ion battery, comprising a positive electrode sheet, a negative electrode sheet, a separator, and an electrolyte, wherein negative electrode sheet comprises a current collector and the self-doped TiNb₂O₇ negative electrode material according to claim 9 loaded on the current collector.
